(19) United States
(12) Patent Application Publication
(10) Pub. No.: US 2022/0050305 A1
(43) Pub. Date: Feb. 17, 2022

(54) FLOATABLE EYEGLASSES STRUCTURE

(71) Applicants: SUN SIGHT GLASSES CO., LTD., TAINAN (TW); XIAMEN SUN HAVEN OPTICAL CO., LTD., XIAMEN CITY (CN)

(72) Inventor: JUI-CHI LI, TAINAN (TW)

(21) Appl. No.: 16/993,573

(22) Filed: Aug. 14, 2020

(51) Int. Cl. G02C 5/00; G02C 5/14

(52) U.S. Cl. CPC G02C 5/008; G02C 5/14

(57) ABSTRACT

The present invention discloses a floatable eyeglasses structure. It has an overall density less than or equal to a density of the water and comprises an eyeglasses frame and two temples. Each of the two temples comprises a front temple hinged to the eyeglasses frame, a rear temple and a sealing ring. The front temple or the rear temple has a slot, and the other one has an insertion block for correspondingly inserting into the slot. The sealing ring is further provided between the slot and the insertion block to form a sealed hollow cavity therebetween.

### BACKGROUND OF THE INVENTION

### 1. Field of the Invention

The present invention relates to a floatable eyeglasses structure which is floating in water automatically when dropped into water.

### 2. Description of Related Art

Traditional eyeglasses are easily sunk into the water due to heavy temples thereof. If the traditional eyeglasses wear by a user are dropped into the water when the user is playing water sports or fishing, the traditional eyeglasses will be quickly sunk into the water due to its weight and unable to find which is inconvenient to use and wasting. Floatable eyeglasses are then developed. The floatable eyeglasses have hollow cavities respectively disposed in its two temples and an overall density thereof is less than a density of the water. Therefore, the floatable eyeglasses are floating in the water when dropped into the water and thus it is convenient to be picked up.

Each of the two temples of the traditional floatable eyeglasses usually comprises a front temple and a rear temple. The front temple is connected to the rear temple by an ultrasonic welding technique to form a hollow cavity therebetween. However, the floatable eyeglasses have problems as below:

1. The ultrasonic welding technique used to connect the front temple and rear temple has higher technological requirement, so a process to connect the front temple and rear temple is more complicated. In addition, a welding location between the front temple and rear temple is usually not tightly connected and the hollow cavity in the temple is not completely sealed. Therefore, the water will infiltrate into the hollow cavity in the temple and cause the floatable eyeglasses to sink when the floatable eyeglasses are dropped into the water.

2. The front temple and rear temple of the floatable eyeglasses are connected by the ultrasonic welding technique, the welding location will become fragile after a period of time, so the temples will be broken and the floatable eyeglasses cannot work properly.

3. The ultrasonic welding technique used to connect the front temple and rear temple is performed by a specific machine, so it is not convenient to assemble the temples and the process to assemble the temples is more complicated.

Therefore, the disadvantages abovementioned need to be improved.

### SUMMARY OF THE INVENTION

The present invention relates to a floatable eyeglasses structure which is convenient to assemble a pair of temples and enhances airtightness of hollow cavities of the temples.

A floatable eyeglasses structure of the present invention is achieved by the following technical features.

The floatable eyeglasses structure has an overall density less than or equal to a density of the water, and comprises an eyeglasses frame and two temples respectively hinged to two laterals of the eyeglasses frame. Each of the two temples has a front temple hinged to the eyeglasses frame and a rear temple. The front temple or the rear temple has a slot, and the other one has an insertion block for correspondingly inserting into the slot. A sealing ring is disposed between the slot and the insertion block to form a sealed hollow cavity between the slot and the insertion block.

According to an embodiment of the abovementioned floatable eyeglasses structure, the insertion block has an annular groove, and the sealing ring is placed in the annular groove and closely attached to an inner wall of the slot by an outer surface thereof.

According to an embodiment of the abovementioned floatable eyeglasses structure, the slot has a notch on an inner wall thereof, and the insertion block has a buckle at a lateral for fastening to the notch.

According to an embodiment of the abovementioned floatable eyeglasses structure, the front temple is hinged to the eyeglasses frame by a front terminal thereof and has the insertion block at a rear terminal thereof, and the rear temple has the slot having an opening facing to the front temple at a front terminal thereof.

The floatable eyeglasses structure of the present invention has advantages described below:

1. The front temple or the rear temple of the floatable eyeglasses structure of the present invention has a slot, and the other one has an insertion block for correspondingly inserting into and fastening with the slot. In addition, a sealing ring is disposed between the slot and the insertion block to form a sealed hollow cavity. Therefore, it is convenient and easy to assemble the temples of the present invention since the front temple and the rear temple is connected by a buckled manner.

2. The sealing ring disposed between the insertion block and the slot guarantees the sealed hollow cavity in a sealed status and prevents affecting a buoyancy of the present invention due to water seeping into the sealed hollow cavity.

### BRIEF DESCRIPTION OF THE DRAWINGS

FIG. 1 is a stereogram showing a floatable eyeglasses structure of the present invention;

FIG. 2 is an exploded diagram showing a floatable eyeglasses structure of the present invention;

FIG. 3 is a top view showing a floatable eyeglasses structure of the present invention in an exploded state;

FIG. 4 is a first sectional diagram showing a floatable eyeglasses structure in assembly of the present invention in assembly;

FIG. 5 is a second sectional diagram showing a floatable eyeglasses structure in assembly of the present invention in assembly.

### DETAILED DESCRIPTION OF THE PREFERRED EMBODIMENT

To provide a thorough understanding, the purpose and advantages of the present invention will be described in detail with reference to the accompanying drawings:

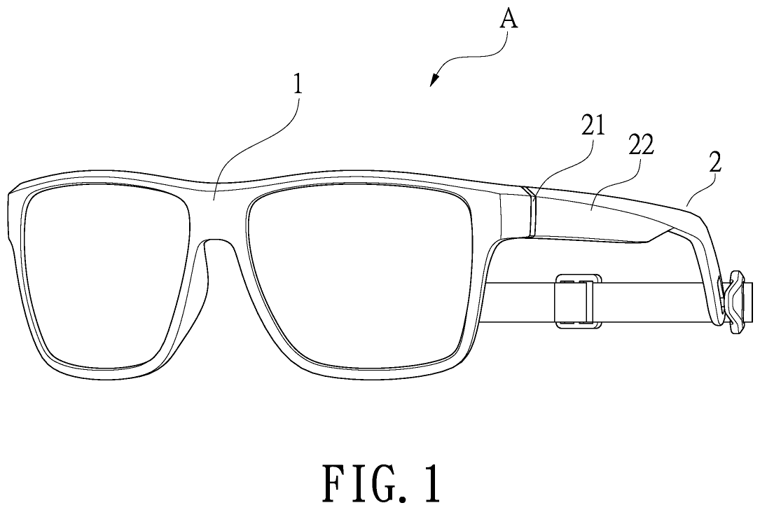

Please referring to FIG. 1 to FIG. 5, a floatable eyeglasses structure (A) is disclosed by the present invention. The floatable eyeglasses structure (A) has a density less than or equal to a density of the water so as to float in the water.

The floatable eyeglasses structure (A) comprises an eyeglasses frame (1) and two temples (2). Each of the eyeglasses frame (1) and the two temples (2) has a density less than or equal to a density of the water. The two temples (2) are respectively hinged to two laterals of the eyeglasses frame (1). Each of the two temples (2) has a front temple (21) and a rear temple (22). The front temple (21) is hinged to the eyeglasses frame (1) by a pin shaft (3), and the rear temple (22) is connected to the front temple (21). A sealed hollow cavity (20) is formed between the front temple (21) and the rear temple (22) to lighten a weight of the temple (2).

The eyeglasses frame (1) can be made of Grilamid TR XE 11207 (EMS-CHEMIE AG), the front temple (21) can be made of GRILAMID TROGAMID CX (TR90), and the rear temple (22) can be made of Grilamid TR XE 11207 (EMS-CHEMIE AG). Therefore, the weight of io the floatable eyeglasses structure (A) is decreased.

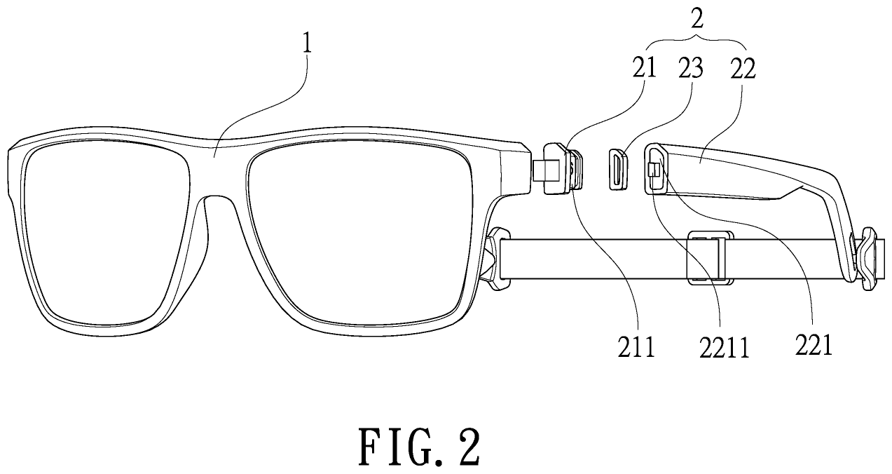

Referring to FIG. 2 to FIG. 5, the front temple (21) has an insertion block (211) and the rear temple (22) has a slot (221). The insertion block (211) is inserted into and fastened with the slot (221) for connecting the front temple (21) to the rear temple (22). So, it is more convenient to assemble the temples (2) of the present invention when comparing to the ultrasonic welding technique used to connect temples of the traditional floatable eyeglasses. In addition, the present invention improves the defect of having a fragile welding location of the traditional floatable eyeglasses. The temple (2) of the present invention further has a sealing ring (23) sealed between the insertion block (211) and the slot (221) for sealing the sealed hollow cavity (20) formed between the front temple (21) and the rear temple (22). Therefore, the sealing ring (23) guarantees the sealed hollow cavity (20) in a sealed status and keeps the sealed hollow cavity (20) of the temple (2) tightly sealed.

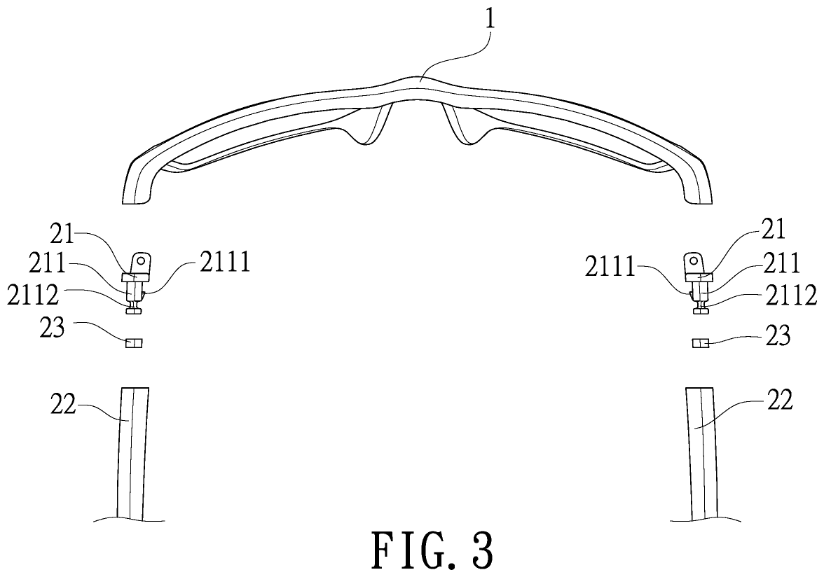

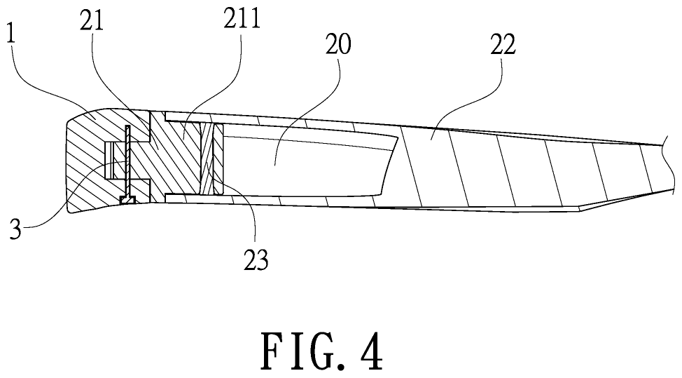

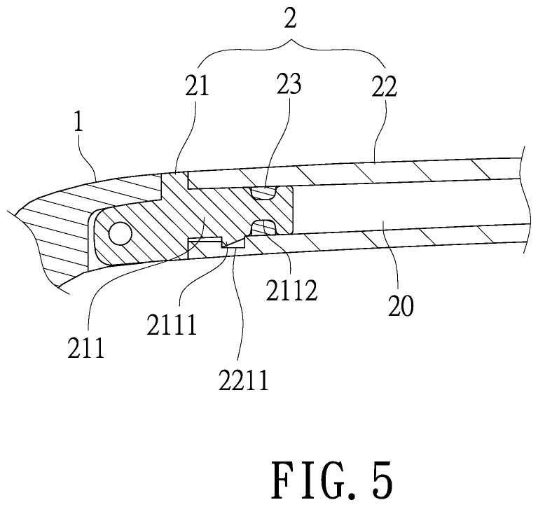

Referring to FIG. 2, FIG. 3 and FIG. 5, the slot (221) has a notch (2211) on an inner wall thereof, and the insertion block (211) has a buckle (2111) at a lateral for fastening to the notch (2211) so as to buckle the insertion block (211) with the slot (221). The insertion block (211) further has an annular groove (2112). The sealing ring (23) is placed in the annular groove (2112) and closely attached to an inner wall of the slot (221) by an outer surface of the sealing ring (23) to tightly seal the sealed hollow cavity (20). Please referring to FIG. 4, the front temple (21) is hinged to the eyeglasses frame (1) by a front terminal thereof and has the insertion block (211) at a rear terminal thereof. The rear temple (22) has the slot (221) at a front terminal thereof, and the slot (221) has an opening facing the front temple (21). is It is worth noting that the insertion block (211) of the present invention can be disposed at the rear temple (22) instead of at the front temple (21), and the slot (221) can be disposed in the front temple (21) instead of in the rear temple (22), and the front temple (21) and the rear temple (22) still can be assembled to form the sealed hollow cavity (20) therebetween.

What is claimed is:

1. A floatable eyeglasses structure, comprising:
an eyeglasses frame, wherein a density of the eyeglasses frame is less than or equal to a density of the water; and
two temples respectively hinged to two laterals of the eyeglasses frame and having a density less than or equal to a density of the water, each further having a front temple hinged to the eyeglasses frame, a rear temple for connecting to the front temple, and a sealing ring, wherein the front temple or the rear temple has a slot and the other one has an insertion block for correspondingly inserting into the slot, and wherein the sealing ring is sealed between the slot and the insertion block to form a sealed hollow space.

2. The floatable eyeglasses structure as claimed in claim 1, wherein the insertion block has an annular groove, and wherein the sealing ring is placed in the annular groove and closely attached to an inner wall of the slot by an outer surface thereof.

3. The floatable eyeglasses structure as claimed in claim 1, wherein the slot has a notch on an inner wall thereof, and wherein the insertion block has a buckle at a lateral for fastening to the notch.

4. The floatable eyeglasses structure as claimed in claim 1, wherein the front temple is hinged to the eyeglasses frame by a front terminal thereof and has the insertion block at a rear terminal thereof, and wherein the rear temple has the slot having an opening facing the front temple at a front terminal thereof.
